(19) United States
(12) Patent Application Publication
(10) Pub. No.: US 2021/0131767 A1
(43) Pub. Date: May 6, 2021

(54) System Optimizing Control Coefficients Of Flight Object Under Complex Environmental Effects Using Hybrid Fuzzy Logic And Pid Variant Controller

(71) Applicant: VIETTEL GROUP, Ha Noi City (VN)

(72) Inventors: Van Duc Tran, Kien Xuong District (VN); Tien Dat Nguyen, Ha Noi City (VN); Thi Anh Nguyen, An Thi District (VN)

(73) Assignee: VIETTEL GROUP, Ha Noi City (VN)

(21) Appl. No.: 17/084,316

(22) Filed: Oct. 29, 2020

(30) Foreign Application Priority Data
Oct. 30, 2019 (VN) 1-2019-06083

(51) Int. Cl. F41G 7/00; F41G 7/22; G06N 7/02

(52) U.S. Cl. CPC F41G 7/006; G06N 7/023; F41G 7/2246; F41G 7/2226

(57) ABSTRACT

The invention presents a system optimizing control coefficients of flight object under complex environmental effects using hybrid Fuzzy Logic and PID variant controller. The proposed system includes: target module, seeker module, guidance module, control module, dynamics module. The fuzzy logic controller is applied to determine the parameters coefficients of a proportional integral derivative (PID) based on the effect of these coefficients on the system response. The control module is less affected by the accuracy of the mathematical model and can perform well in environments with impact noise.

### FIELD OF THE INVENTION

The Invention generally relates to optimizing the control coefficients of a flight object under the complex effect of environment using Fuzzy logic controller and variant of traditional proportional-integral-derivative controller (PID controller).

### BACKGROUND

The disclosed system proposes a method for designing a new controller by combining two known controllers and defining optimal parameters for the new one. Generally, to simulate and build a controller, previous methods use only a single controller such as PI, PID or state feedback controller and define parameters based on traditional methods. The specific case to be presented here is to use a PID controller and its variant to control the flying weapon, the controller coefficients are determined by traditional methods such as Ziegler_Nichols, Thomas-Reiche-Kuhn sum rule or the magnitude and symmetric optimization techniques. An overview of the model is shown in FIG. 1.

The disadvantage of a classical system when building a weapon controller in a simulation system is the reduction in environmental factors, since classical methods are very sensitive to noise. In particular, to simplify the simulation process, the traditional system eliminates turbulent flow factors, which not only decreases the accuracy of the model and but also has a relatively low practicability. Therefore, taking into account environmental interference in flying weapon simulation would help obtain more accurate reconstruction of objects as well as external factors impacting them, thereby increase the feasibility and applicability of the simulation.

In addition, the traditional method used to determine the coefficients of the classical controller (PID) is unsuitable for objects such as controlled weapons with a large dynamic range and non-linear aerodynamic properties. For a controlled flying weapon, its transfer function changes continuously with Mach number (ratio of the speed of the flying weapon to the speed of sound); therefore, applying a Fuzzy Logic Controller and a normal PID would make the system unstable or even uncontrollable. Combining the Fuzzy Logic Controller with new variant of PID controller not only resists interference for the system but also keep it stable and controllable. An overview of the model is shown in FIG. 2.

### SUMMARY

The purpose of the invention is to propose a new control model and system for optimizing control coefficients of flight object under the effect of environment; in which fuzzy logic controller and PID variant are utilized to determine real-time parameters for the controller.

To achieve above objective, the following modules are applied:

Target module is to establish movement rules and report state of the target in each simulation step, including mathematical equations being formulated to describe motion of the target.

Seeker module is to do comparing calculations to determine deviations of position, velocity, angle between the target and the flying weapon in a fixed reference frame. These data are extracted from the state of target provided by the target module and the state of flying weapon obtained after the dynamic module solving differential equations at each step.

Guidance module based on guidance law generates control signals as input signals for control module to move actuators of the flying weapon toward a designated direction.

Control module is to calculate the coefficients of the controller using the hybrid Fuzzy Logic and PID variant Controller. Input of the control module is desired control signals (acceleration, angle, angular velocity) provided by the guidance module; the fuzzy logic controller tunes the parameters of PID variant controller based on the effect of these parameters on the system response.

Dynamic module calculates all states of the flight object by solving differential equations of motion that are constructed by applying the dynamic equations and Newton's second law.

In the present invention, the Fuzzy Logic Controller tunes the coefficients of PID variant controller based on effects of these coefficients on the system response. The control module is less affected by the accuracy of the mathematical model and able to perform effectively in environments with interference.

### DESCRIPTION OF THE DRAWINGS

FIG. 1 is a block diagram of simulation modeling of control flight objects and classical method for determining parameters of the control system;

FIG. 2 is a block diagram of simulation modeling having environmental interference, hybrid fuzzy logic and PID controller;

FIG. 3a is block diagram of Fuzzy Logic Controller structure;

FIG. 3b is a block diagram of applying hybrid fuzzy logic to adjust control coefficients

FIG. 3c is a block diagram of PID Variant Controller structure; and

FIG. 4 is block diagram of environmental interference.

### THE DETAILED DESCRIPTION OF THE INVENTION

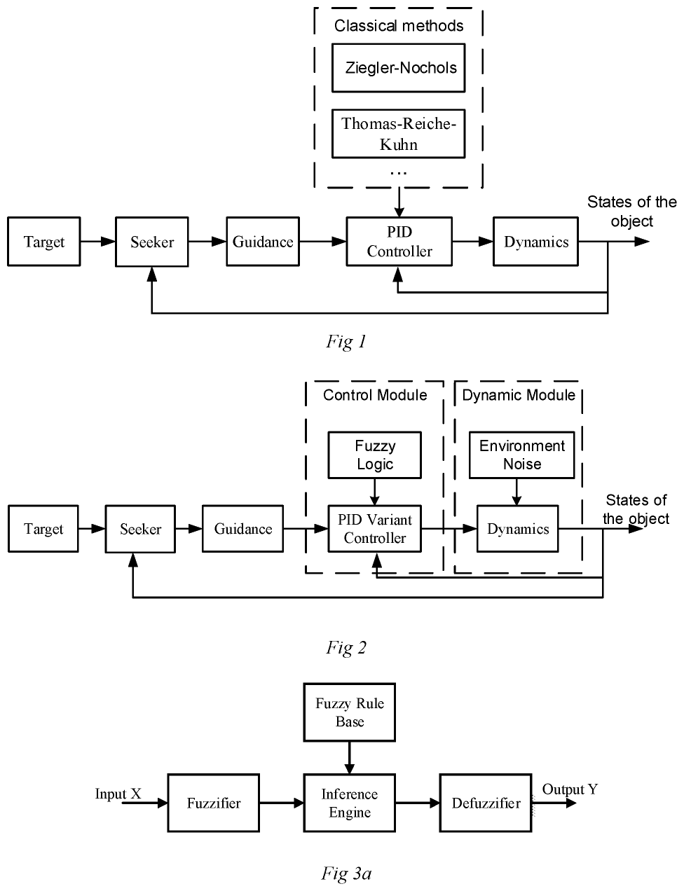

Following FIG. 2, the invention mentions the optimal control coefficients of flight object under environmental influence using the Fuzzy Logic Controller and PID variant controller.

The detailed description has specialized terminology:

PID is the abbreviation of Proportional (P), Integrate (I), and Derivative (D).—three main components in the controller.

Variants of PID Controller are PI, PD, PID controllers or a combination of these controllers with feedback signals.

Fuzzy logic is a method of reasoning resembling the manner of human decision making, which approaches matters based on “degrees of truth” rather than the usual “true or false” (1 or 0) Boolean logic, thereby considering all available information and making the best possible decision.

ER is the error between input and feedback signal.

CER is the change of the error (derivative of ER).

μ_{B}, is the membership function.

LOS (Line-of-sight) is the angle between the line linking from the center of the seeker on the weapon to center of the target and the axis of the fixed coordinate system.

LOS rate is derivative of LOS by time.

Guided flying weapon refers two main weaponry: guided bomb and missile.

Environmental effect refers to wind Shear, wind Gust, and wind Dryden affecting velocity and angular velocity of the object.

The transfer function describes the relation between input and output signal of the system.

The actuator is known as the ballistic control surface.

System optimizing control coefficients of flight object under complex environmental effects using hybrid Fuzzy Logic and PID variant controller is located in Control Module to continuously determine coefficients of the controller. The system includes:

Target Module:

The function of the target module is to create a target model. Specifically, The module establishes movement rules and reports state of the target in each simulation step. The model of target is chosen appropriately to the type of weapon. In fact, there are 4 types of flying weapon: air to air, air to surface, surface to surface, surface to air. The target model includes data on velocity, acceleration and position of target moving in the space in case of air to air and surface to air; moving on the ground in case of air to surface and surface to surface. The target is also can be fixed on the ground. Mathematical equations describing motion of the target are formulated inside the module based on designer's intention. The orbit may be simplified as go straight, cross or circle. If the designer wants the target to move toward a complex trajectory, the dynamic equations are described under the differential equations form. In this case, the numerical method is used to solve the differential equations to collect the positions of target. The output of this module is the trajectory of the target by time.

Seeker Module:

Inputs of the seeker module are states of the target provided by the target module and states of the weapon calculated by dynamic module from time to time. The Seeker module does comparing calculations to discover error in velocity, position, and angle between the target and the weapon with the fixed coordinate system. An ideal seeker module without instrumentation error and environmental interference would provide mentioned error in velocity, position and angle as output of the module.

Guidance Module:

Guidance module based on guidance law generates control signals as input signals for the control module to move actuators of a flying weapon toward a designated direction. The guidance law is chosen appropriately to the specification and ability of the target (such as moving or fixed). The common guidance methods are based on acceleration, angle, or angular velocity. The control signal is calculated based on the errors from the seeker module depended on different guidance law.

The input of this module is the output of the seeker module. The output of this module is the control signal calculated based on the guidance law.

Control Module:

The main function of the control module is transforming the desired signal from the output of the guidance module to the deflection signal of the actuators. The proposed controller comprises 02 main elements: Fuzzy Logic controller and PID variant controller.

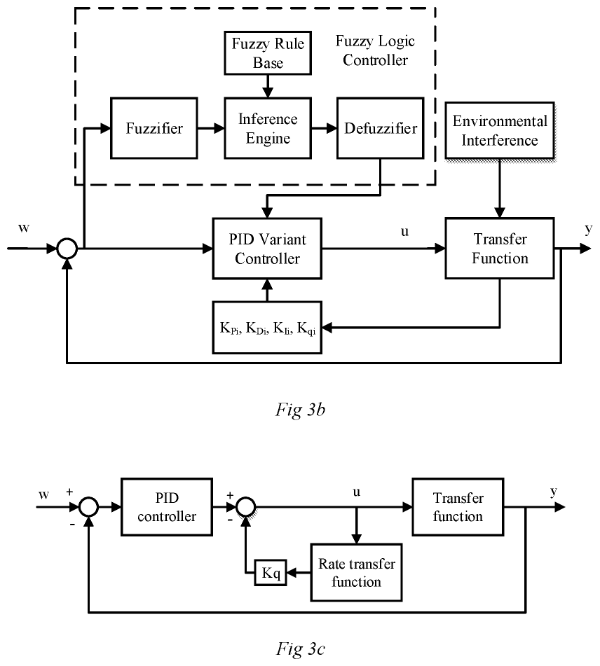

Following the FIG. 3c, the PID variant controller is composed of 02 loops: an outer loop and an additional inner loop. The control signal is converted to channel rate by the rate transfer function. The channel rate feedback is added to the inner loop which controls a short period damping and oscillation making the missile more stable.

The coefficients of the PID variant controller are calculated as in the following equations:

K_{P}=K_{Pi}+ΔK_{P}

K_{D}=K_{Di}+ΔK_{D}

K_{I}=K_{Ii}+ΔK_{I}

K_{q}=K_{qi},

The quantity change of the control coefficients ΔK_{P}, ΔK_{I}, ΔK_{D} is continuously estimated by applying the Fuzzy Logic Controller. Because the transfer function of the system varies according to the March number constanty (the ratio of the speed of the flight object to the speed of sound), it is necessary to choose the appropriate coefficients K_{Pi}, K_{Di}, K_{Ii}, K_{qi} to stabilize the system. The coefficients K_{Pi}, K_{Di}, K_{Ii}, K_{qi} are initial parameters calculated by using the homogeneity method for the denominator of the transfer function and choosing polynomial. For simplicity purposes, the range of motion is divided into a number of small ranges such that in each small range the open-loop transfer function of the system has poles close to each other, each range will have a separate set of K_{Pi}, K_{Di}, K_{Ii}, K_{qi} to ensure stability of the system in that range.

Following the FIG. 3a, the basic model of the Fuzzy Logic Controller is presented in an overall way. The model comprises 04 main components: (1) fuzzifier, (2) fuzzy rule base, (3) inference engine, (4) defuzzifier.

Following the FIG. 3b, details of how to combine the Fuzzy Logic Controller and PID variant controller for the flight object's control system are described. The behavior of Fuzzy Logic Controller is defined as follow:

(i) Fuzzifier: the system response and the quantity change of the control coefficients are fuzzified to the linguistic variables. The system response comprises 02 components: the error and the change of error. The value domain and membership function of each component are different depending on the requirements of each problem.

(ii) Fuzzy Rule-Bases: defining the relationship between the quantity change of the control coefficients and the system response.

(iii) Inference engine: performing fuzzy compositions (fuzzy union, intersection)

(iv) Defuzzifier: producing a quantifiable result of control coefficients from given fuzzy set and corresponding membership function.

The method for designing the Fuzzy Logic Controller for controlling the flight object under the effect of the environment is described as follow:
Fuzzifier: The fuzzy logic takes the error and the change of error of the system as the inputs, and outputs are the quantity change of the control coefficients. The inputs and outputs use five fuzzy sets, corresponding to the linguistic variables: Negative Large (NL), Negative Small (NS), Medium (M), Positive Small (PS), and Positive Large (PL). The domain of parameters is defined as [a; b] and the linguistic variables are chosen as: NL=[a; (3a+b)/4]; NS=[a; (a+b)/2]; M=[(3a+b)/4; (a+3b)/4]; PS=[(a+b)/2; b]; PL=[(a+3b)/4; b]. The quantity value of linguistic variables is resolved by a given membership function μ.
Fuzzy Rule Base: The construction of the fuzzy rule base is based on relationship between control factor and system's response as shown in Table 1.

TABLE 1
RELATIONSHIP CONTROL coefficients—SYSTEM RESPONSE

| Gain | Change | Static Error | Time response | Overshoot |
|---|---|---|---|---|
| K_{P} | Increase | Decrease | Increase | Increase |
| K_{I} | Decrease | Vanish | Small Decrease | Increase |
| K_{D} | Increase | Small Change | Small Decrease | Small Decrease |

From the effect of the control coefficients on the system as shown in Table 1, the rule-bases are described as following principles: if the system's error is Negative Large, long time response {EL=NL, CER=NL}, K_{P}, K_{D} increases and K_{I} decreases by {ΔK_{P}=PL,ΔK_{I}=PL,ΔK_{D}=PL}. If overshoot is high {EL=PL, CER=PL}, the quantity change is by {ΔX_{P}=NL,ΔK_{I}=PS,ΔK_{D}=NL}. According to this principle, the fuzzy rules consist of 25 law satisfying with this control system.
Defuzzifier: A centroidal method is used to quantify results given by fuzzy sets and corresponding membership function, the defuzzied value denoted as y′ using centroidal method is defined as:

$${y}^{′} = \frac{\int y μ ( y ) dy}{\int μ ( y ) dy}$$

Dynamic module incorporating environmental interference of the guided weapon:

The input data of this module are kinetic characteristics, aerodynamic database, and initial conditions of guided weapon.

The dynamic equations of the object are established by applying the kinematic equations, Newton's second law and some assumptions such as the weapon as a rigid body, the body shape symmetry via ZX plane. Combining provided kinetic and aerodynamic data of weapon and dynamic equations representing velocity, angular velocity in body coordinate system (moving with the weapon) to formulate the first order differential equations of position and rotation angle in the fixed coordinate. Newton's second law is applied to make the first order differential equations describing the velocity and angular velocity in the inertia coordinate system. The effects of the environment are directly added to angular velocity and velocity in the moving coordinate system.

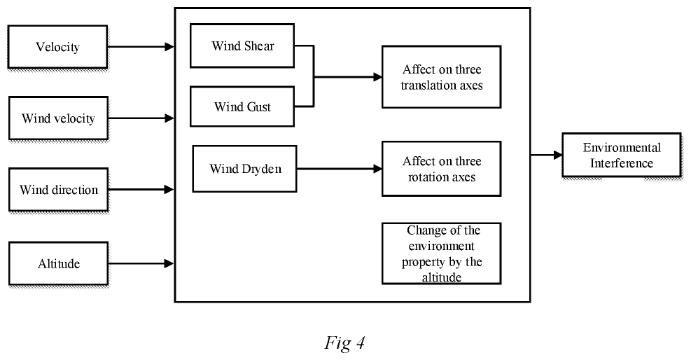

Following the FIG. 4, the environmental interference are created based on the criterion and the previous states of an object. The states (such as altitude, velocity) are continuously updated and then based on the specific characteristic of the weather (such as wind velocity, wind angle, gust amplitude) to calculate wind Shear, wind Gust, and Dryden property in three translation and rotation axes. In addition, the noise model has continuously considered the change in pressure, temperature, air density because of change of altitude. The outputs of the environmental interference model are entered into the dynamic model to calculate the trajectory of the weapon.

There are various numerical methods to solve the differential motion equation system such as Euler, Runge-Kutta, Heun. The Runge-Kutta method is chosen for the high demand for accuracy. Initial conditions of weapon have been already provided (launched from a fixed position on the ground or from another flying object), using numerical method to calculate the weapon states at the subsequent time to the selected step. These states are considered as initial conditions in next step until the weapon destroys the target. The output of the dynamic module incorporating environmental interference are states of the object calculated constantly at each step.

In general, FIG. 2 indicates the work flow of the calculation. The initial conditions of the object are known, states of the target are provided by the target module in each step, seeker module calculates and gives the command signal according with the guidance law for the guidance module, the controller system adjusts control coefficients to move the actuators of the object, the dynamic module receives the control signal, combining with previous states and calculating the current states by numerical method, the states calculated are used as initial conditions for the next step. This process is repeated until the weapon reaches and destroys the target.

1. The system optimizing control coefficients of flight object under complex environmental effects using hybrid Fuzzy Logic and PID variant controller comprising the following main modules:
a target module that establishes movement rules and reports a state of a target in each of a series of simulation steps, including mathematical equations describing movement of the target formulated based on a designer's intention;
a seeker module that compares deviations of a position, a velocity, an angle between the target and a flying weapon in a fixed reference frame, with inputs being a state of the target provided by the target module and a state of the flying weapon obtained after a dynamic module solving differential equations at each simulation step;
a guidance module that Generates a control signals based on guidance law, which are input signals for a control module to move actuators of the flying weapon toward a designated direction;
the control module using a hybrid fuzzy logic controller and a PID variant, calculates coefficients for the hybrid fuzzy logic controller, using input as the desired control signals (acceleration, angle, angular velocity) provided by the guidance module; a Fuzzy Logic Controller determines the parameters of the PID variant controller based on analysis of an effect of changes in control parameters on the system response; and
A dynamics module to incorporate environmental interference establishes differential equations of motion of the flying weapon by applying dynamic equations and Newton's second law.

2. The system of claim 1, further comprising:
The PID variant controller has the following parameters:
K_{P}=K_{Pi}+ΔK_{P}
K_{D}=K_{Di}+ΔK_{D}
K_{I}=K_{Ii}+ΔK_{I}
K_{q}=K_{qi},
The coefficients K_{Pi}, K_{Di}, K_{Ii}, K_{qi} are initial parameters calculated by using the homogeneity method for the denominator of the transfer function and choosing polynomial;
quantity change of the control coefficients ΔK_{P}, ΔK_{I}, ΔK_{D} is continuously estimated by applying the fuzzy logic controller based on the system response; The selection of a fuzzy domain would be based on characteristics of each specific system to optimize the response of the system including overshoot (as small as possible), setting time, and transition time. (as small as possible); range of motion is divided into a number of small ranges such that in each small range the open-loop transfer function of the system has poles close to each other, each range will have a separate set of K_{Pi}, K_{Di}, K_{Ii}, K_{qi} to ensure stability of system in that range; Then, the control module receives the control signals (acceleration, angle, angular velocity) to calculate and give the actuator responses (steering angle, high angle steering angle), Changing in the state of the actuators leads to change in the aerodynamic properties of the flying weapon, thereby altering the state of the flying weapon according to the desired control signal to chase or intercept the target.

3. The system of claim 2, in which
the Fuzzy Logic Controller model includes: a Fuzzifier, a Fuzzy Rule-Bases, an Interference Engine, a Defuzzifier as follows:
the input of the Fuzzifier are the error and the change of the system error, The output of the Fuzzifier is the variable amount of control parameters;
the value domain of the input and output variables is fuzzified to linguistic variables; the apparent value of the variable at the domains defined μ_{B} by a predefined membership function;
Fuzzy Rule-Bases are built based on the relationship between control coefficients and system response;
Defuzifier by Centroidal method is used to quantify results given by fuzzy sets and corresponding membership function, the defuzzied value denoted as y′ using centroidal method is defined as:
$${y}^{′} = \frac{\int y μ ( y ) dy}{\int μ ( y ) dy} .$$

4. The system of claim 1, in which
the Fuzzy Logic Controller model includes: a Fuzzifier, a Fuzzy Rule-Bases, an Interference Engine, a Defuzzifier as follows:
the input of the Fuzzifier are the error and the change of the system error, The output of the Fuzzifier is the variable amount of control parameters;
the value domain of the input and output variables is fuzzified to linguistic variables; the apparent value of the variable at the domains defined μ_{B} by a predefined membership function;
Fuzzy Rule-Bases are built based on the relationship between control coefficients and system response;
Defuzifier by Centroidal method is used to quantify results given by fuzzy sets and corresponding membership function, the defuzzied value denoted as y′ using centroidal method is defined as:
$${y}^{′} = \frac{\int y μ ( y ) dy}{\int μ ( y ) dy} .$$
